(19) United States
(12) Patent Application Publication
(10) Pub. No.: US 2026/0369108 A1
(43) Pub. Date: Nov. 19, 2026

(54) SMART INSTALL VEHICLE TRACKING UNIT

(71) Applicant: Verizon Patent and Licensing Inc., Basking Ridge, NJ (US)

(72) Inventors: Sean McGinn, Dublin (IE); Anton Wigley, Kilternan (IE)

(21) Appl. No.: 19/208,784

(22) Filed: May 15, 2025

(51) Int. Cl. G07C 5/08; G07C 5/00

(52) U.S. Cl. CPC G07C 5/0808; G07C 5/008; G07C 5/0816

(57) ABSTRACT

According to some embodiments, a vehicle tracking unit includes a diagnostic connector, a vehicle interface configured to receive diagnostic data through the diagnostic connector, a routing unit connected between the diagnostic connector and the vehicle interface and configured to selectively map lines in the diagnostic connector to inputs of the vehicle interface according to a first configuration, and a processor. The processor is configured to receive a first set of parameter data in the diagnostic data from the vehicle interface in the first configuration, and responsive to identifying a missing element in the first set of parameter data, configure the routing unit to selectively map the lines according to a second configuration.

### BACKGROUND

Telematics systems typically collect data from a host vehicle in a vehicle tracker unit (VTU) and wirelessly transmit the data to a central computer system. The computer system then analyzes the data to monitor the vehicle. Conventional telematics systems collect diagnostic data, measured from the engine computer of the host vehicle, and location-based data, measured with a global positioning system (GPS).

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram of a vehicle tracking unit, according to some embodiments.

FIG. 2 is a logic diagram illustrating diagnostic port mapping logic, in accordance with some embodiments.

FIG. 3 is a flow diagram illustrating an example method for establishing a vehicle diagnostic connection, in accordance with some embodiments.

FIG. 4 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

According to some embodiments, a vehicle tracking unit includes a diagnostic connector, a vehicle interface configured to receive diagnostic data through the diagnostic connector, a routing unit connected between the diagnostic connector and the vehicle interface and configured to selectively map lines in the diagnostic connector to inputs of the vehicle interface according to a first configuration, and a processor. The processor is configured to receive a first set of parameter data in the diagnostic data from the vehicle interface in the first configuration and responsive to identifying a missing element in the first set of parameter data, configuring the routing unit to selectively map the lines according to a second configuration.

Telematics systems that monitor light-duty automobiles and trucks beginning with model year 1996 measure data from an on-board diagnostic (OBD-II) system of the host vehicle. OBD-II systems, as mandated by the Environmental Protection Agency (EPA), monitor the vehicle's electrical, mechanical, and emissions systems and generate data that are processed by an engine control module (ECM) to detect malfunctions or deterioration in the vehicle's performance. Communication protocols used to access OBD-II data include J1850 PWM (Ford vehicles), J1850 VPWM (General Motors), ISO 9141-2 (Toyota), KWP2000 (Hyundai, Mercedes), and CAN (proposed for next-generation vehicles). Data monitored with these protocols typically include parameters such as vehicle speed (VSS), engine speed (RPM), fuel percentage, fuel used, derived odometer, dash odometer, engine load (LOAD), and mass air flow (MAF). The ECM can also generate diagnostic trouble codes (DTCs), which are 5-digit codes (e.g., ‘P0001’) indicating electrical/mechanical problems with the vehicle. Most vehicles manufactured after 1996 include a standardized, 16-cavity serial diagnostic connector that makes these data available. The diagnostic connector serially communicates with the vehicle's ECM and typically lies underneath the vehicle's dashboard.

A number of vehicle manufacturers use different pin-outs for the secondary ODB-ii Bus, on which key ECM data is sent. In such instances, a vehicle tracker unit (VTU) connected to the diagnostic connector using a default pin-out will not be able to read all of the diagnostic data via the diagnostic connector.

In some embodiments, a VTU installed in a host vehicle includes detection logic to identify an alternative ODB pin-out and a routing unit configured to selectively remap the lines in a diagnostic connector to inputs of a vehicle interface corresponding to alternative pin-out configurations. The diagnostic connector remapping facilitates the use of VTUs in a wider variety of vehicle makes, years, and models.

VTUs may be useful in a wide range of host vehicles. Examples of such vehicles include automobiles and trucks, as well as commercial equipment, medium and heavy-duty trucks, construction vehicles (e.g., front-end loaders, bulldozers, forklifts), powered sport vehicles (e.g., motorboats, motorcycles, all-terrain vehicles, snowmobiles, jet skis, and other powered sport vehicles), collision repair vehicles, marine vehicles, and recreational vehicles. VTUs may be useful in the vehicle care industry. Although diagnostic systems operating under OBD-II and J1708 communication protocols are disclosed herein for illustrative purposes, it is to be appreciated that embodiments may be employed with other systems.

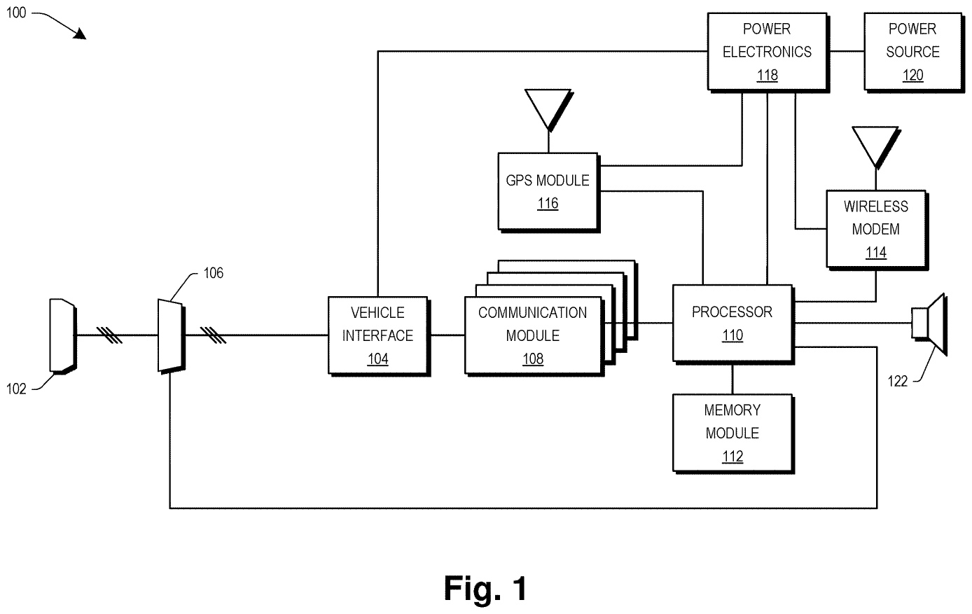

FIG. 1 is a schematic drawing of a VTU 100 according to an embodiment of the present invention. In some embodiments, the VTU 100 comprises a diagnostic connector 102 for interfacing with a corresponding diagnostic port of a host vehicle, a vehicle interface 104 for receiving data over lines of the diagnostic connector 102, a routing unit 106 configured to selectively map lines in the diagnostic connector 102 to inputs of the vehicle interface 104 to facilitate alternate pinouts, communication modules 108 for communicating with the host vehicle using various communication protocols according to host vehicle type, a processor 110 and associated memory module 112 for operating the VTU 100, a wireless modem 114 for communicating data generated by the VTU 100, a global positioning system (GPS) module 116 for tracking the location of the host vehicle, power electronics 118 for selectively conditioning power from the diagnostic connector 102 or a power source 120 (e.g., a battery) for powering the elements of the VTU 100 (e.g., processor 110, wireless modem 114, or GPS module 116), and an output device 122 (e.g. a speaker, LED, or other output device).

The processor 110 operates according to instructions that generate diagnostic and location-based data associated with the host vehicle and formats the data for wireless transmission using the wireless modem 114 to an Internet-accessible central computer system. In some embodiments, the wireless modem 114 may be a cellular model, a satellite modem, some other type of modem, or multiple modems offering different choices for communication protocol.

The processor 110 communicates with the host vehicle through the vehicle interface 104 through the diagnostic connector 102 connected to a diagnostic port of the host vehicle (e.g., a 16-cavity OBD-II diagnostic connector for light-duty cars and trucks or 6-cavity J1708 diagnostic connector for medium and heavy-duty trucks). The diagnostic port of the host vehicle may be located underneath the steering column of the host vehicle to provide direct access to diagnostic data stored in memory of the engine control unit (ECU) of the host vehicle. The communication modules 108 implement separate communication protocols for different vehicle buses (e.g., those featured in Ford, GM, Toyota, Hino, Hyundai, Next-Gen Vehicles, or some other bus). The communication modules 108 can be integrated into a single ASIC wherein each communication module 108 is a separate integrated circuit. In some embodiments, the processor 110 or supervisory logic in the ASIC detect the communication protocol of the host vehicle and select the appropriate protocol to communicate with the host vehicle. In some embodiments, the processor 110 reads the vehicle identification number (VIN) of the host vehicle to determine the year, make, and model to select the appropriate communication module 108 for communicating with the ECU.

In some embodiments, the processor 110 stores firmware and pre-processed and/or post-processed diagnostic data in the memory module 112. The memory module 112 may store an operating system (e.g., Linux) that runs on the processor 110. During operation, the memory module 112 may function as a data logger where diagnostic and location-based data are captured at high rates (e.g., every 200 milliseconds) and then read out at a later time.

In some embodiments, the power electronics 118 comprises power-conditioning circuits that receive DC power (e.g., 12V) from the diagnostic connector 102 and supply regulated DC power to at least one of the processor 110, the wireless modem 114, or the GPS module 116. For example, the diagnostic connector 102 is connected to a battery of the host vehicle and the voltage is switched to a lower voltage (e.g., 3.3-5V) to power elements of the VTU 100. In some embodiments, the power source 120 is an internal battery connected to the power electronics 118 to supply power in the event the VTU 100 is disconnected from the host vehicle. In some embodiments, the power electronics 118 recharge the power source 120 to facilitate the provision of back-up power even after extended use.

After connecting to the host vehicle, the processor 110 receives the VIN and enables the communication module 108 appropriate for the host vehicle type. Once the appropriate communication module 108 and associated protocol is selected, the vehicle interface 104 receives diagnostic data from the host vehicle and passes it through the active communication module 108 to the processor 110. In some embodiments, the routing unit 106 uses a default configuration for mapping the connectors in the diagnostic connector 102 to the inputs of the vehicle interface 104 according to different configurations. Currently, a default pin-out configuration is used by about 75-80% of vehicles.

TABLE 1
Pin-out Configurations

| | Standard Connections | Non-Standard |
|---|---|---|
| Can Bus# | (pins) | Connections (pins) |
| 1 (High Speed) | 6 & 14 | 6 & 14 |
| 2 (Medium Speed) | 3 & 11 | 3 & 8 |

In some embodiments, the routing unit 106 is a relay block that provides alternate routing paths from the diagnostic connector 102 to the inputs of the vehicle interface 104 based on an alternate routing flag being set or cleared. Alternatively, the routing unit 106 comprises integrated circuit devices (e.g., transistors) that provides alternate routing paths from the diagnostic connector 102 to the inputs of the vehicle interface 104 based on the alternate routing flag being set or cleared. The routing unit 106 may be mounted to a printed circuit board with other components of the VTU 100, integrated into a wiring harness including the diagnostic connector 102, provided in a separate semiconductor die, or integrated into a semiconductor die with one of the other components of the VTU 100.

Using the default-pin-out configuration of the routing unit 106, the processor 110 receives and processes diagnostic data from the active communication module 108 and location-based data from the GPS module 116. Example host vehicle data received by the processor 110, referred to as parameter IDs (PIDs), include VIN, engine RPM, vehicle speed, fuel percentage remaining, fuel used, derived odometer reading, and dash odometer reading. Depending on the host vehicle type, not all of the data may be present. For example, a host vehicle may provide one of fuel percentage remaining or fuel used and one of derived odometer or dash odometer.

In the case where the host vehicle employs an alternate pin-out, the host vehicle data set received by the processor 110 may be incomplete. If the processor 110 detects an incomplete host vehicle data set, the processor 110 configures the routing unit 106 to select an alternative pin-out configuration that remaps one or more of the data lines from the diagnostic connector 102 to the vehicle interface 104. Although the present examples use a default pin-out configuration and an alternative pin-out configuration, in some embodiments, the number of alternative pin-out configurations may vary, and the processor 110 may cycle through the various pin-out configurations until the host vehicle data set is complete.

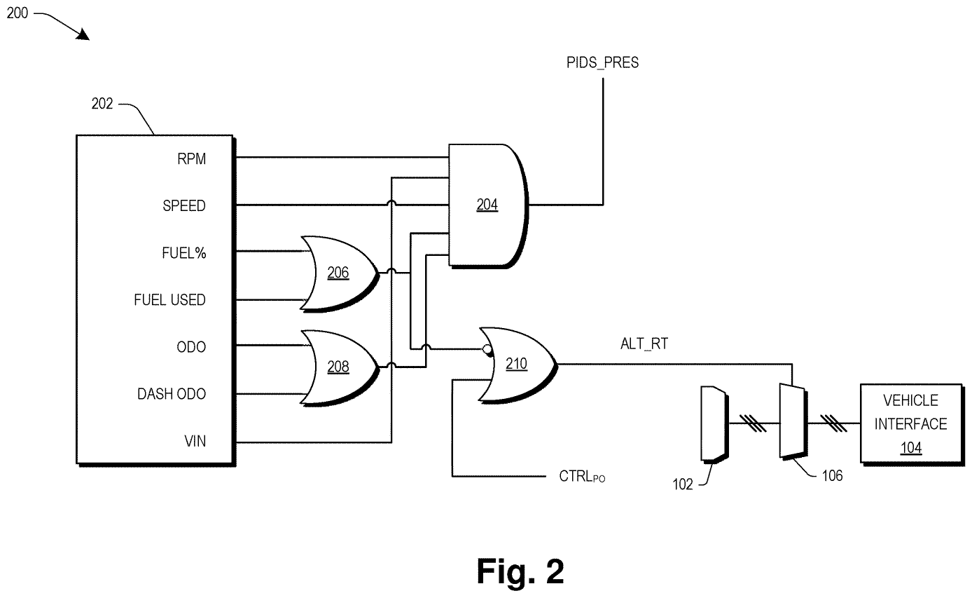

FIG. 2 is a logic diagram illustrating diagnostic port mapping logic 200, in accordance with some embodiments. The processor 110 implements the diagnostic port mapping logic 200 using instructions and data values rather than actual logic gates. PIDs received over the diagnostic connector 102 are stored in a diagnostic register 202. In some embodiments, the diagnostic port mapping logic 200 comprises an AND gate 204, OR gates 206, 208, and an OR gate 210 with an inverted input connected to the OR gate 206. If data is successfully received for a parameter, the PID for that data is referred to as being present. The OR gate 206 generates a logic one output if either the fuel percentage remaining PID or the fuel used PID is present. The OR gate 208 generates a logic one output if either the derived odometer PID or the dash odometer PID is present. The AND gate 204 generates a logic one output (PIDS_PRES) if the RPM PID is present, the VIN PID is present, the speed PID is present, one of the fuel PIDs is present based on the output of the OR gate 206, and one of the odometer PIDs is present based on the output of the OR gate 206.

In some embodiments, the absence of both fuel PIDs is used as a trigger to set the alternate routing flag (ALT_RT) indicating that an alternative pin-out is used in the diagnostic port of the host vehicle. Other triggers or multiple triggers may be used. In some embodiments, the alternate routing flag may be set using a control flag (CTRL_{PO}), for example, sent by an over-the-air (OTA) command sent to the VTU 100 and stored in the memory module 112. The OR gate 210 sets the alternate routing flag (ALT_RT) if the inverted output of the OR gate 206 is a logic one indicating that no fuel PID is present or if the control flag (CTRL_{PO}) is set at a logic one. Other structures and/or configurations of the diagnostic port mapping logic 200 are within the scope of the present disclosure.

In some embodiments, after the routing unit 106 is reconfigured to select the alternate pin-out configuration, the processor 110 determines if the PIDS_PRES flag is set indicating proper operation and stores the value of the alternate routing flag (ALT_RT) in a persistent state to force the alternate routing after a subsequent restart so the logic analysis need not be repeated unless the VTU 100 is removed and installed in a different host vehicle.

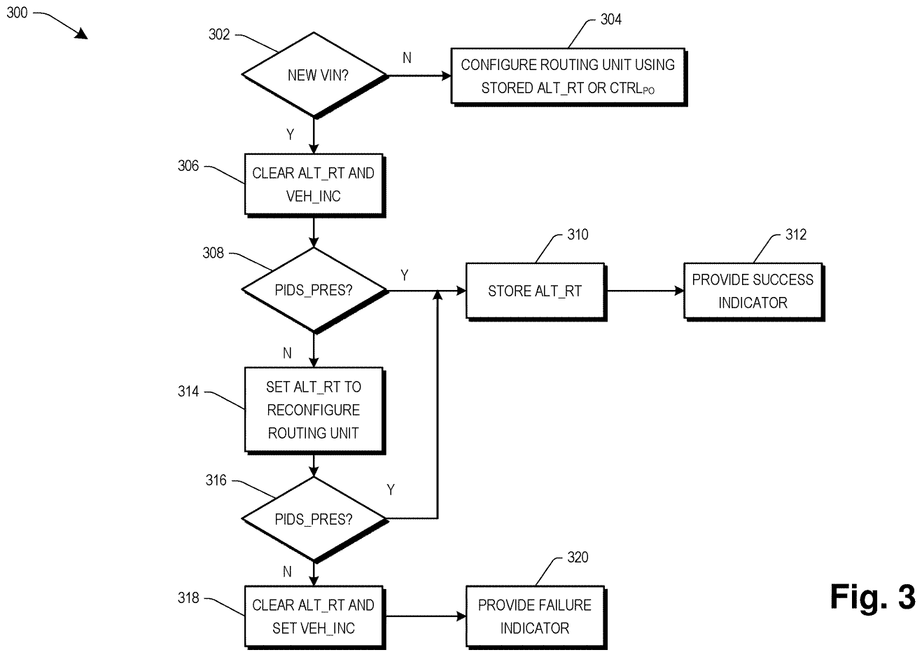

FIG. 3 is a flow diagram illustrating an example method 300 for establishing a vehicle diagnostic connection, in accordance with some embodiments. At 302, the processor 110 determines if a new VIN is received over the diagnostic connector 102. If a new VIN is not received at 302, the processor 110 configures the routing unit 106 using the previously stored value of the alternate routing flag (ALT_RT), e.g., “0” for default pin-out configuration and “1” for alternate pin-out configuration at 304. If the control flag (CTRL_{PO}) is set, the processor 110 configures the routing unit 106 using the alternate routing at 304, overriding the alternate routing flag (ALT_RT).

If a new VIN is received at 302, the processor 110, the processor 110, at 306, clears the alternate routing flag (ALT_RT) to restore the default pin-out configuration and clears a vehicle incompatibility flag (VEH_INC) indicating a previous installation failure for the VTU 100. The processor 110 determines if the PIDS_PRES flag is set at 308, indicating successful retrieval of all PIDs. If the PIDS_PRES flag is set at 308, the processor 110 stores the current state of the alternate routing flag (ALT_RT) at 310 and provides a success indicator at 312. The success indicator may be an audible indicator or visual indicator (e.g., LED pattern) provided by the output device 122.

If the PIDS_PRES flag is not set at 308, the processor 110 sets the alternate routing flag (ALT_RT) to the alternate pin-out value (e.g., “1”) and reconfigures the routing unit 106 at 314. After reconfiguring the routing unit 106, the processor 110 determines if the PIDS_PRES flag is set at 316, indicating successful retrieval of all PIDs. If the PIDS_PRES flag is set at 316, the processor 110 stores the current state of the alternate routing flag (ALT_RT) at 310 and provides a success indicator at 312.

If the PIDS_PRES flag is not set at 316, the processor 110 clears the alternate routing flag (ALT_RT) to the default pin-out value (e.g., “0”) and sets the vehicle incompatibility flag (VEH_INC) indicating a configuration failure at 318. The processor 110 provides a failure indicator at 320. The failure indicator may be an audible indicator or a visual indicator provided by the output device 122 that is different than the success indicator.

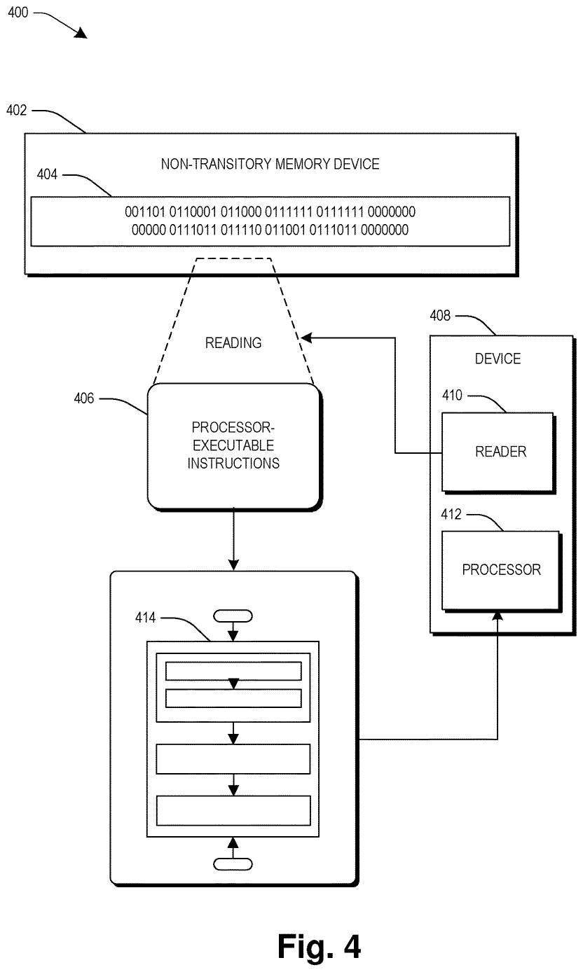

FIG. 4 is an illustration of a scenario 400 involving an example non-transitory machine-readable medium 402. The non-transitory machine readable medium 402 may comprise processor-executable instructions 406 that when executed by a processor 412 cause performance (e.g., by the processor 110) of at least some of the provisions herein. The non-transitory machine readable medium 402 may comprise a memory semiconductor device (e.g., a semiconductor device utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine-readable medium 402 stores machine-readable data 404 that, when subjected to reading by a reader 410 of a device 408 (e.g., a read head of a hard disk drive, or a read operation invoked on a solid-state storage device), express the processor-executable instructions 406. In some embodiments, the processor-executable instructions 406, when executed cause performance of operations 414, such as at least some of the example method of FIG. 3, for example. In some embodiments, the processor-executable instructions 406 are configured to cause implementation of a system.

Automatically configuring the VTU 100 to be compatible with different pin-outs for the diagnostic port of the host vehicle increases the number of vehicles in which the VTU 100 can be successfully installed, simplifies the installation process, and provides feedback to the installer. In some embodiments, the configuration state of the VTU 100 may be communicated to the central computer system by embedding the alternate routing flag (ALT_RT) and the incompatibility flag (VEH_INC) in outgoing data packets.

Data analyzed by a VTU, including diagnostic and location-based data, may be used to improve conventional services such as roadside assistance, vehicle theft notification and recovery, and remote diagnostics. For example, the data can indicate a vehicle location, fuel level, battery voltage, and any active DTCs. With this information a call center can dispatch a tow truck with the appropriate materials (e.g., extra gasoline or tools required to repair a specific problem) to service the vehicle accordingly. A VTU according to embodiments described herein can be easily transferred from one vehicle to another, or easily replaced in the event of malfunction. No additional wiring is required to install the VTU, and the automatic pin-out detection increases the number of vehicles that may use the VTU.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A vehicle tracking unit, comprising:
a diagnostic connector;
a vehicle interface configured to receive diagnostic data through the diagnostic connector;
a routing unit connected between the diagnostic connector and the vehicle interface and configured to selectively map lines in the diagnostic connector to inputs of the vehicle interface according to a first configuration; and
a processor configured to:
receive a first set of parameter data in the diagnostic data from the vehicle interface in the first configuration; and
responsive to identifying a missing element in the first set of parameter data, configure the routing unit to selectively map the lines according to a second configuration.

2. The vehicle tracking unit of claim 1, comprising:
an output device, wherein:
the processor is configured to:
receive a second set of parameter data in the diagnostic data from the vehicle interface in the second configuration; and
responsive to identifying a missing element in the second set of parameter data, generate a failure indicator on the output device.

3. The vehicle tracking unit of claim 2, wherein:
the missing element in the second set comprises a fuel parameter.

4. The vehicle tracking unit of claim 1, comprising:
an output device, wherein:
the processor is configured to:
receive a second set of parameter data in the diagnostic data from the vehicle interface in the second configuration; and
responsive to identifying that the second set of parameter data is complete, generate a success indicator on the output device.

5. The vehicle tracking unit of claim 1, wherein:
the routing unit comprises at least one of a relay or a transistor.

6. The vehicle tracking unit of claim 1, comprising:
a memory configured to store a control flag, wherein:
the processor is configured to:
configure the routing unit to selectively map the lines according to the second configuration responsive to the control flag being set.

7. The vehicle tracking unit of claim 1, comprising:
a memory configured to store an alternative routing flag, wherein:
the processor is configured to:
responsive to identifying the missing element in the first set of parameter data, set the alternative routing flag; and
responsive to the alternative routing flag being set, configure the routing unit to selectively map the lines according to the second configuration.

8. The vehicle tracking unit of claim 1, comprising:
a memory configured to store an alternative routing flag, wherein:
the first set of parameter data comprises a first vehicle identification parameter; and
the processor is configured to:
receive a second set of parameter data in the diagnostic data from the vehicle interface; and
responsive to identifying a second vehicle identification parameter in the second set of parameter data different than the first vehicle identification parameter, reset the alternative routing flag and configuring the routing unit to selectively map the lines according to the first configuration.

9. A method, comprising:
connecting a diagnostic connector to a diagnostic port of a host vehicle;
receiving diagnostic data in a vehicle interface through the diagnostic connector;
configuring a routing unit connected between the diagnostic connector and the vehicle interface to selectively map lines in the diagnostic connector to inputs of the vehicle interface according to a first configuration;
receiving a first set of parameter data in the diagnostic data from the vehicle interface in the first configuration; and
responsive to identifying a missing element in the first set of parameter data, configuring the routing unit to selectively map the lines according to a second configuration.

10. The method of claim 9, comprising:
receiving a second set of parameter data in the diagnostic data from the vehicle interface in the second configuration; and
responsive to identifying a missing element in the second set of parameter data, generating a failure indicator on an output device.

11. The method of claim 9, wherein:
identifying the missing element comprises identifying a missing fuel parameter.

12. The method of claim 9, comprising:
receiving a second set of parameter data in the diagnostic data from the vehicle interface in the second configuration; and
responsive to identifying that the second set of parameter data is complete, generating a success indicator on an output device.

13. The method of claim 9, wherein:
configuring the routing unit comprises configuring at least one of a relay or a transistor.

14. The method of claim 9, comprising:
storing a control flag in a memory; and
configuring the routing unit to selectively map the lines according to the second configuration responsive to the control flag being set.

15. The method of claim 9, comprising:
storing an alternative routing flag in a memory;
responsive to identifying the missing element in the first set of parameter data, setting the alternative routing flag; and
responsive to the alternative routing flag being set, configuring the routing unit to selectively map the lines according to the second configuration.

16. The method of claim 9, wherein:
the first set of parameter data comprises a first vehicle identification parameter; and
the method comprises:
storing an alternative routing flag in a memory;
receiving a second set of parameter data in the diagnostic data from the vehicle interface; and
responsive to identifying a second vehicle identification parameter in the second set of parameter data different than the first vehicle identification parameter, resetting the alternative routing flag and configuring the routing unit to selectively map the lines according to the first configuration.

17. A non-transitory computer-readable medium, storing instructions thereon that when executed by a processor cause the processor to:
receive diagnostic data from a vehicle interface through a diagnostic connector;
configure a routing unit connected between the diagnostic connector and the vehicle interface to selectively map lines in the diagnostic connector to inputs of the vehicle interface according to a first configuration;
receive a first set of parameter data in the diagnostic data from the vehicle interface in the first configuration; and
responsive to identifying a missing element in the first set of parameter data, configure the routing unit to selectively map the lines according to a second configuration.

18. The non-transitory computer-readable medium of claim 17, wherein the processor is configured to:
receive a second set of parameter data in the diagnostic data from the vehicle interface in the second configuration;
responsive to identifying a missing element in the second set of parameter data, generate a failure indicator on an output device; and
responsive to identifying that the second set of parameter data is complete, generate a success indicator on the output device.

19. The non-transitory computer-readable medium of claim 17, wherein the processor is configured to:
store an alternative routing flag in a memory;
responsive to identifying the missing element in the first set of parameter data, set the alternative routing flag; and
responsive to the alternative routing flag being set, configure the routing unit to selectively map the lines according to the second configuration.

20. The non-transitory computer-readable medium of claim 17, wherein the processor is configured to:
store an alternative routing flag in a memory;
receive a second set of parameter data in the diagnostic data from the vehicle interface; and
responsive to identifying a first vehicle identification parameter in the second set of parameter data different than a second vehicle identification parameter in the first set of parameter data, reset the alternative routing flag and configure the routing unit to selectively map the lines according to the first configuration.
